(19) United States
(12) Patent Application Publication
(10) Pub. No.: US 2012/0117054 A1
(43) Pub. Date: May 10, 2012

(54) Query Analysis in a Database

(76) Inventors: Lakshmikant Shrinivas, Billerica, MA (US); Sreenath Bodagala, North Andover, MA (US); Matthew Steven Fuller, Medfield, MA (US); Charles Edward Bear, Hudson, MA (US)

(21) Appl. No.: 13/291,711

(22) Filed: Nov. 8, 2011

Related U.S. Application Data
(60) Provisional application No. 61/411,389, filed on Nov. 8, 2010.

(51) Int. Cl. G06F 17/30

(52) U.S. Cl. 707/713; 707/E17.131

(57) ABSTRACT

A method of analyzing an expression to infer output data properties, comprises storing, in a storage device, a root node “e” in R, in which “e” is an expression and R is a root node of an abstract syntax tree (AST) of the expression “e”, storing a number of child nodes of R into C₁, . . . Cₙ, with a processor coupled to the storage device, calling analyze(Cᵢ), storing output properties of expression C into Pᵢ I, and determining if any of the child nodes Cᵢ in {C₁ . . . Cₙ} has not been analyzed, in which if the last child node has been analyzed, with the processor, calling compute-output-properties(R, P₁, . . . Pₙ), storing, in the storage device, the result in Pₒᵤₜₚᵤₜ, and returning Pₒᵤₜₚᵤₜ as the output properties of the expression “e.”

### RELATED DOCUMENTS

The present application claims the benefit under 35 U.S.C. §119(e) of U.S. Provisional Application No. 61/411,389, filed Nov. 8, 2010. This application is herein incorporated by reference in its entirety.

### BACKGROUND

Expressions in structured query language (SQL) may be used in database expression analysis to logically eliminate rows from a query result. When used this way, SQL expressions are referred to as predicates. An SQL predicate expression comprises column references, constants, scalar functions, scalar sub-queries, and other operators combined by rules set forth by the SQL programming standards. A predicate expression is evaluated for each row and outputs one of “true,” “false,” or “NULL” (i.e., unknown). Column references use the value of the column at the row being evaluated. An evaluation of “false” or “unknown” indicates the row will be filtered out or eliminated.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a data processing system, according to one example of the principles described herein.

FIG. 2 is an abstract syntax tree (AST) for an expression, according to one example of the principles described herein.

FIG. 3 is a flow chart depicting a method of analyzing an expression to infer the output data, according to one example of the principles described herein.

FIG. 4 is a flow chart depicting a method of determining output properties of a single node, given the output properties of the children of the node in connection with A and B of FIG. 3, according to one example of the principles described herein.

FIG. 5 is a block diagram of a predicate evaluation for a query, according to one example of the principles described herein.

FIG. 6 is a flowchart depicting a method of eliminating records from a query result in a database expression analysis, according to one example of the principles described herein.

FIG. 7 is a flowchart depicting a method of eliminating records from a query result in a database expression analysis, according to another example of the principles described herein.

Throughout the drawings, identical reference numbers designate similar, but not necessarily identical, elements.

### DETAILED DESCRIPTION

Many components of a database system could benefit greatly if the components had more knowledge of the values an expression might produce before the query is executed. For example, if a user had foreknowledge of an expression input value range, the user may be able to determine if the expression would evaluate to “true.” Thus, it would be unnecessary to spend processing cycles and resources on evaluating an expression the user would know the system would always evaluate to “true.”

Another use by database systems may include examining the data statistics and the expression to employ some form of partition or block elimination. However, this mechanism only works with simple predicates. If a more complex expression predicate was built on top of a simple predicate, the block elimination scheme fails to work.

The present data processing system and method infers a set of properties of output data, given an expression and a set of properties about input data. The present system and method can be used to avoid evaluation of the expression on the entire input data, and thus speed up predicate evaluation, when the expression is a predicate and the input data is sorted. The present system and method can be used to avoid retrieving portions of the data when the expression is a predicate and the input data is partitioned and where the properties of each range or partition includes the minimum and maximum values of data stored in the range. Properties can include information on whether the data they describe is sorted, and if so, how the data is sorted. Further, properties can include information on whether the data they describe is a single value. Still further, properties can include information on how the data they describe is distributed across multiple computers in examples where the data processing system comprises multiple computers. Even still further, properties can include the minimum and maximum values of the data they describe. Even still further, properties can include information on whether the data they describe contains NULL values.

The present system and method can be used to compute selectivity of a predicate when the expression is a predicate. The present system and method can be used to avoid sorting data, when the properties include information about how the data is sorted. The present system and method can also be used to avoid transferring data between computers, when the properties include information about how the data they describe is distributed across multiple computers, and the data processing system comprises multiple computers.

The present system and method, using a database, associates with each table column in a query a respective value range that represents minimum and maximum possible values of the table column, associates a respective value range that represents minimum and maximum possible output values resulting from evaluation of an operator based on associated value ranges of a number of inputs to the operator, identifies a number of the operators that would evaluate to false based on associated value ranges of their inputs, and outputs records corresponding to a number of operators that evaluate to true to an output device. The system and method further does not analyze records for which the operators would evaluate to false. In this manner, the system and method evaluate a query without evaluating the identified operators.

As used in the present specification and in the appended claims, the term “data processing device” is meant to be understood broadly as any device that processes data. Examples of data processing devices include a programmable processor, a computer, a system on a chip, an analytic database, a relational database, a non-relational database, a structured database, a stream processing system, an in-memory database, a key-value database, and combinations thereof. In one example, the data processing device includes special purpose logic circuitry, such as, for example, a field programmable gate array (FPGA) of application-specific integrated circuit (ASIC).

The data processing device includes hardware or a combination of hardware and code that creates an execution environment for a computer program used in connection with the data processing device. In one example, the computer program used in connection with the data processing device is code that constitutes processor firmware, a protocol stack, a database management system, an operating system, a cross-platform runtime environment, a virtual machine, or combinations thereof. The data processing device and the execution environment created by the data processing device comprise a number of different computing model infrastructures such as, for example, web services, distributed computing, grid computing infrastructures, and combinations thereof. The data processing system may or may not have persistent storage of the data, and may be a distributed as well as a non-distributed system.

In one example, the data processing device is a relational database. In another example, the data processing device is a VERTICA® analytic database developed by Vertica Systems, Inc. of 8 Federal Street, Billerica Mass. 01821 and owned by Hewlett-Packard Development Co. L.P. composed of HPQ Holdings, LLC, of 11445 Compaq Center Dr., West Houston, Tex. 77070.

Further, as used in the present specification and in the appended claims, the term “expression” or similar language is meant to be understood broadly as any expression defined by the SQL standard such as, for example, the SQL-92 standard or any mathematical expression. In one example, the expression may produce either scalar values or tables consisting of columns and rows of data.

Still further, as used in the present specification and in the appended claims, the term “query” or similar language is meant to be understood broadly as any specification for a set of data retrieved from a data store. In one example, a query may comprise a statement, or combination of statements, that constitute a request for information from a database that is based on a number of conditions. In another example, a query may be a component of an SQL statement that specifies a result set. In one example, a query may be a subquery; a sub-select used within a predicate, for example, a select-statement within the WHERE or HAVING clause of another SQL statement.

Even still further, as used in the present specification and in the appended claims, the term “a number of” or similar language is meant to be understood broadly as any positive number comprising 1 to infinity; zero not being a number, but the absence of a number.

Even still further, as used in the present specification and in the appended claims, the term “portion” or similar language is meant to be understood broadly as any amount of a whole including the whole. In one example, a portion of a table column may include any percentage of the table column including 100% or all of the table column.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

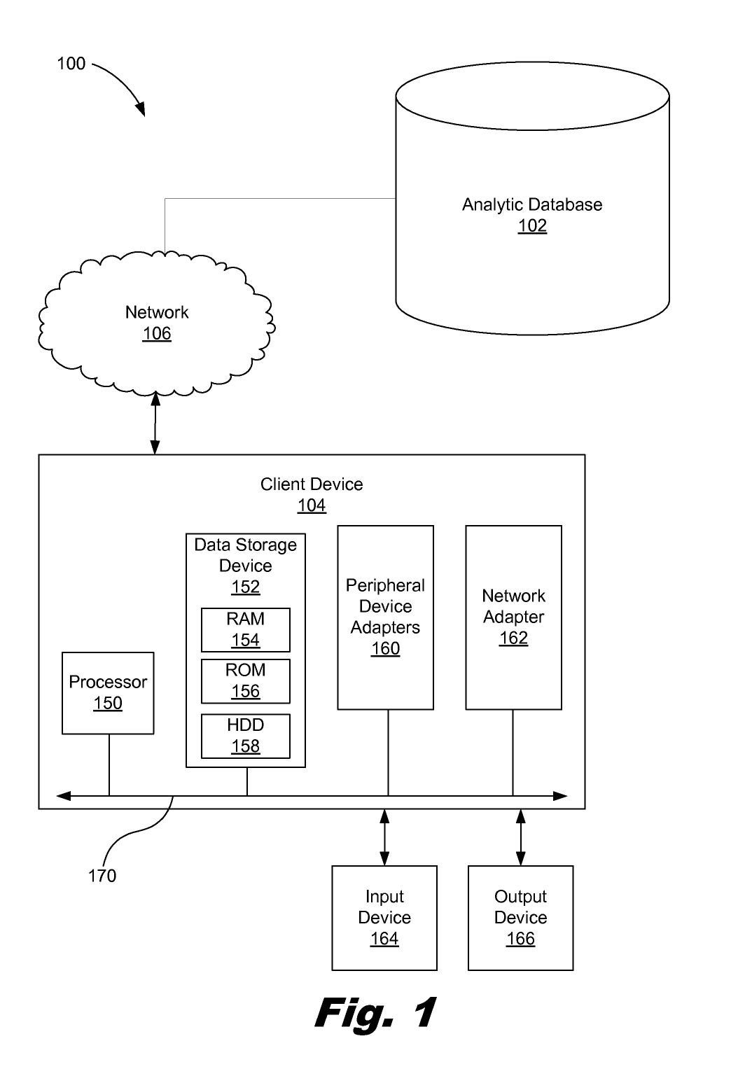

Referring now to the figures, FIG. 1 is a diagram of a data processing system (100), according to one example of the principles described herein. The system (100) includes an analytic database (102) communicatively coupled to a client device (104) via a network (106). In the present example, for the purposes of simplicity in illustration, the analytic database (102) and the client device (104) are separate computing devices communicatively coupled to each other through a mutual connection to the network (106). However, the principles set forth in the present specification extend equally to any alternative configuration in which the client device (104) has complete access to the analytic database (102).

As such, alternative examples within the scope of the principles of the present specification include, but are not limited to, examples in which the client device (104) and analytic database (102) are implemented by the same computing device. Another is an example in which the functionality of the client device (104) and analytic database (102) is implemented by multiple interconnected computers, for example, a server in a data center and a user's client machine. Still another is an example in which the client device (104) and analytic database (102) communicate directly through a bus without intermediary network devices. Still further is an example in which the client device (104) has a stored local copy of the analytic database (102). In these examples, the analytic database (102) is used to associate with each table column in a database query performed by the client device (104), having a number of operators, a respective value range that represents minimum and maximum possible values of the table column. Upon receiving a query from another computing device such as, for example, the client device (104), the analytic database (102) associates, for each of a number of the operators in the query, a respective value range that represents minimum and maximum possible output values resulting from evaluation of the operator based on associated value ranges of a number of inputs to the operator. The analytic database (102) identifies a number of the operators that would evaluate to false based on associated value ranges of their inputs, and evaluates the query without evaluating the identified operators.

The analytic database (102) returns to the client device (104) those values that satisfy the predicates that were used by the query as search criteria in the analytic database (102). The client device (104) may store the returned data in the data storage device (152) or display the data on the output device (166). In one example, the client device (104) is a desktop computer with the capability of issuing a request to the analytic database (102), and displaying returned data via the output device (166).

To achieve its desired functionality, the client device (104) includes various hardware components. Among these hardware components are a processor (150), a data storage device (152), peripheral device adapters (160), and a network adapter (162). These hardware components may be interconnected through the use of a number of busses and/or network connections. In one example, the processor (150), data storage device (152), peripheral device adapters (160), and a network adapter (162) are communicatively coupled via bus (170).

The processor (150) includes the hardware architecture that retrieves executable code from the data storage device (152) and executes the executable code. The executable code, when executed by the processor (150), causes the processor (150) to implement at least the functionality of issuing a request to the analytic database (102), and displaying returned data via the output device (166) upon execution of the application according to the methods of the present specification described below. In the course of executing code, the processor (150) may receive input from and provide output to a number of the remaining hardware units.

The data storage device (152) may store data such as data or metadata representing a the returned values from the analytic database (102) The data storage device (152) specifically saves data associated with the results of the query issued by the processor (150) and performed by the analytic database (102). The data storage device (152) includes various types of memory modules, including volatile and nonvolatile memory. For example, the data storage device (152) of the present example includes Random Access Memory (RAM) (154), Read Only Memory (ROM) (156), and Hard Disk Drive (HDD) memory (158). Many other types of memory are available in the art, and the present specification contemplates the use of many varying type(s) of memory in the data storage device (152) as may suit a particular application of the principles described herein. In certain examples, different types of memory in the data storage device (152) are used for different data storage needs. For example, in certain examples the processor (150) may boot from Read Only Memory (ROM) (156), maintain nonvolatile storage in the Hard Disk Drive (HDD) memory (158), and execute program code stored in Random Access Memory (RAM) (154).

Generally, the data storage device (152) may comprise a computer readable storage medium. For example, the data storage device (152) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this specification, a computer readable storage medium may be any tangible medium that can contain, or store a program for use by or in connection with an instruction execution system, apparatus, or device.

The hardware adapters (160, 162) enable the processor (150) to interface with various other hardware elements, external and internal to the client device (104). For example, peripheral device adapters (160) may provide an interface to input/output devices, such as, for example, input device (164) and output device (166), a keyboard, a mouse, a display device, or external memory devices to create a user interface and/or access external sources of memory storage. As will be discussed below, a number of output devices (166) may be provided to allow a user to interact with the data returned to the client device (104) from the analytic database (102). For example, the output device (166) may be a display for displaying a user interface for the client device (104). In another example, the output device (166) may be a printer for printing information processed by the analytic database (102) and client device (104). In still another example, the output device (166) may be an external data storage device for storing data returned from the analytic database (102).

The network adapter (162) provides an interface to the network (106), thereby enabling the transmission of data to and receipt of data from devices on the network (106), including, for example, the client device (104) and analytic database (102). The network (106) may include, for example, a local area network (LAN), a wide area network (WAN), a virtual private network (VPN), the Internet, and a peer-to-peer network, among others.

In the present specification, an analytic database (102) associates with each table column in a database query comprising a number of operators a respective value range that represents minimum and maximum possible values of the table column. The analytic database (102) associates, for each of a number of the operators in the query, a respective value range that represents minimum and maximum possible output values resulting from evaluation of the operator based on associated value ranges of a number of inputs to the operator, and identifies a number of the operators that would evaluate to false based on associated value ranges of their inputs. The system (100) thus evaluates the query without evaluating the identified operators. Further, an operator is a function taking a number of arguments. A query includes a function taking no arguments, and further comprises associating a respective value range with the function. The query can include a constant, further comprising associating a respective value range with the constant in which minimum and maximum values of the respective value range are equal to the constant. A minimum or maximum value for a respective value range of an operator can be unknown. The table column can be partitioned and the value range associated with the table column comprises a value range for each partition. The table column can be partitioned into a plurality of partitions and each partition's values may be stored in a sorted order.

In one example, the present expression analysis framework may be used in a variety of components within the VERTICA® analytic database. Using the expression analysis framework, components in the database can extract information about the range of values that can be produced by any arbitrarily complex predicate. In analytic databases (102), the additional overhead of expression analysis is justified since query planning time usually comprises a very small fraction of the total execution time.

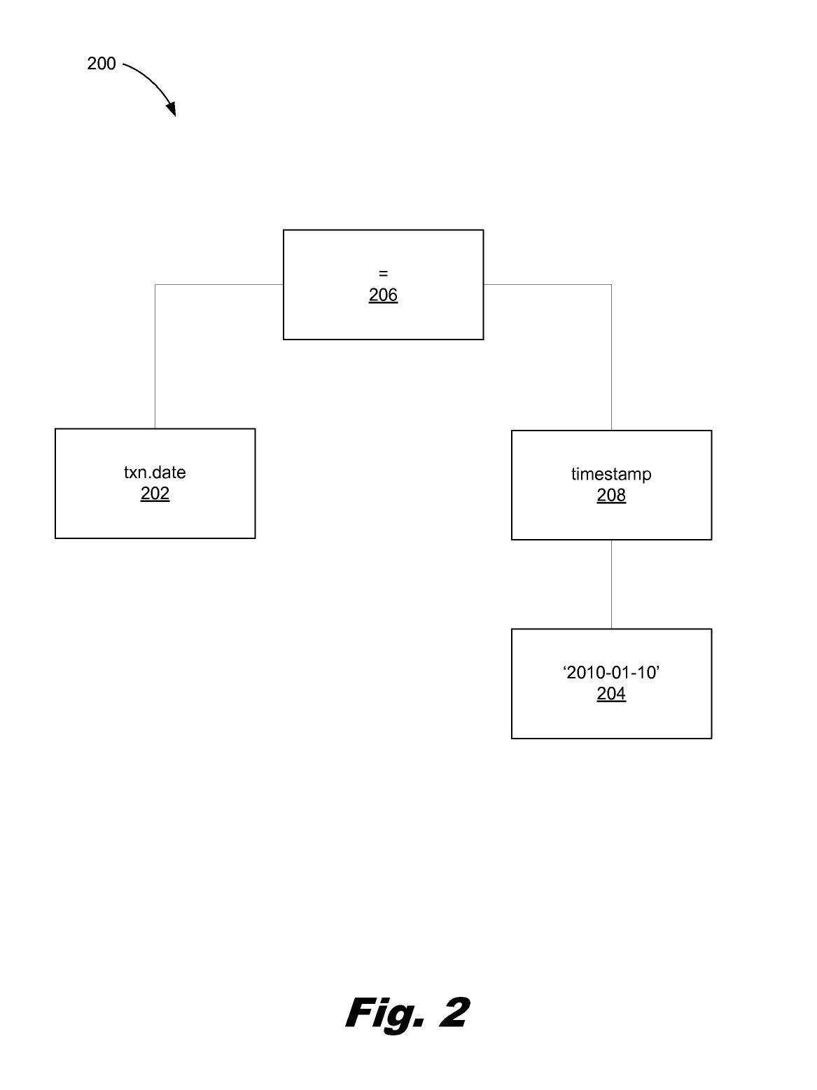

The expression analysis framework is utilized by the analytic database (102) for deducing useful information about expressions. The examples described herein use the following schema, Schema 1, and the example AST expression shown in FIG. 2.

CREATE TABLE item(

| | |
|---|---|
| id | INTEGER PRIMARY KEY, |
| name | VARCHAR(100), |
| comment | VARCHAR(200) |

);
CREATE TABLE txn(

| | |
|---|---|
| txn_id | INTEGER PRIMARY KEY, |
| date | TIMESTAMP NOT NULL, |
| itm_id | INTEGER REFERENCES item(id), |
| price | NUMERIC(10,2) |

Schema 1

FIG. 2 is an abstract syntax tree (AST) for an expression, according to one example of the principles described herein. For the purposes of evaluation, an expression is compiled into an abstract syntax tree (AST) (200). In the context of a database, the leaf nodes (202, 204) of the AST are column references, constants, or scalar functions with no arguments. The internal nodes (206, 208) represent functions with arguments and operators. FIG. 2 shows an example AST for the expression txn.date=‘2010-01-10’.

For each leaf node (202, 204) that represents a column reference, there is a stream of possibly ordered values that against which the expression is evaluated. For example, if the predicate shown in FIG. 2 is evaluated on a table txn, then the stream of values for the column reference txn.date is the set of values present in the date column of the txn table. The result of evaluating the expression over the input is a stream of values, each of which is true, false, or NULL, depending on the corresponding value of the date column in the input stream.

The AST (200) of an expression is leveraged to infer useful information about the stream of values produced upon its execution. This information is encoded in the form of a tuple (L, H, O, N), known as a value range. In a value range, L and H are the low and high bounds for the values in the stream. O can be one of the values Unordered, Non-decreasing, Non-increasing, or Constant. In a VERTICA® analytic database (102), columns are stored sorted on disk, query operators preserve sortedness as far as possible, and this information is tracked. Thus, sorted streams of data can be found at various points during plan execution. Further, within the tuple (L, H, O, N), N indicates whether the stream can contain SQL-NULL's. For example, the tuple (1, 5, Non-decreasing, false) indicates that the stream of values that it refers to, for example S, satisfies the following properties:

1. ∀sεS, 1≦s≦5
2. ∀sᵢ, sⱼεS, i<j [symbol] sᵢ≦sⱼ
3. ∀sεS, s≠NULL

Each node (202, 204, 206, 208) in the AST (200) produces a value range describing the stream of values generated by that node (202, 204, 206, 208) upon execution, possibly using the value ranges of its input(s). By default, column references produce value ranges in which the low (L) and high (H) bound are unbounded. However, the order and null-presence terms may be significant. For example, if a column is sorted ascending on disk, and cannot contain nulls (due to SQL constraints), then its value range is:

(unbounded, unbounded, Non-decreasing, false)

As described below, the low (L) and high (H) bounds for column references are sometimes known, in which case the value range can be refined further. A constant C (which is not SQL-NULL) has a value range:

### (C, C, Constant, False)

Function (208) and operator (206) nodes compute their value ranges from the value ranges of their inputs. For example, consider the expression txn.date=‘2010-01-10’, whose AST is depicted in FIG. 2. Suppose the value range for the txn.date column reference is:

(2007-01-01, 2009-12-31, Non-decreasing, true)
The value range for the constant ‘2010-01-10’ is:
(2010-01-10, 2010-01-10, Constant, false)

Then, since the bounds for the input value ranges do not overlap, the resulting value range for the expression is:

### (False, False, Constant, True)

The output value range indicates that the stream of values generated upon expression evaluation will contain either False or NULL. Thus, if some information about column references in an expression is known, the expression analysis framework described above allows a user to infer useful information about the expression prior to evaluation.

Some example applications of expression analysis for improving query performance as well as improving cardinality estimates during query optimization will now be described. In a VERTICA® analytic database, during table creation, a user may specify a partitioning clause. The partitioning clause specifies how data in the table is partitioned on disk. Users are not restricted to specifying ranges for columns; data can be partitioned according to any arbitrary expression, as long as it does not contain functions whose values depend on environment settings, or which change with each invocation. A partition is created for each unique value of the partition expression. For example, the txn table may be partitioned as follows:

CREATE TABLE txn(

| | |
|---|---|
| txn_id | INTEGER PRIMARY KEY, |
| date | TIMESTAMP NOT NULL, |
| itm_id | INTEGER REFERENCES item(id), |
| price | NUMERIC(10,2) |

)
PARTITION BY EXTRACT (year FROM date) II

EXTRACT (quarter FROM date);

Schema 2

This will create one partition for each quarter of each year of data present in the date column. Each partition is stored in a number of containers on disk. The number of containers per partition is internally managed by an analytic database, for example, a VERTICA® analytic database. Further, the number of containers per partition could change over time. For each container within a partition, the minimum and maximum values for each column appearing in the partition expression is stored. In the example above, each container for each partition of the txn table has the minimum and maximum values of the date column. These values form the basis for inputs to the expression analysis framework.

During predicate evaluation, the predicate expression is analyzed by feeding in the bounds for each container for each partition of the table. For example, suppose the user issues the following query:

SELECT * FROM txn
WHERE extract (year from date) = 2010;

When the query is evaluated, the predicate ‘extract (year from date)=2010’ is analyzed for each container of each partition of the txn table. The value range for the date column is constructed using the minimum and maximum values present in the container, as well as NULL constraints and sort order, if any. If the predicate can never be true for some container, then the entire container is skipped without reading any data off disk. Note that the predicate in the query does not use the partition expression for the table. Indeed, any predicate on the date column could potentially benefit from such partition pruning. Unlike the approach in other databases, which only works with simple predicates, a VERTICA® analytic database's (102) expression analysis framework can be used to yield performance improvements for queries with arbitrarily complex predicates.

In, for example, a VERTICA® analytic database (102), data is stored sorted on disk. Coupled with the fact that a VERTICA® analytic database (102) is a column store database, this gives several advantages, such as better compression, allowing merge joins and pipelined aggregation (also referred to as stream aggregation). Often primary key and other high cardinality columns are stored sorted. The data for such columns is stored in a number of containers on disk, and each container is sorted.

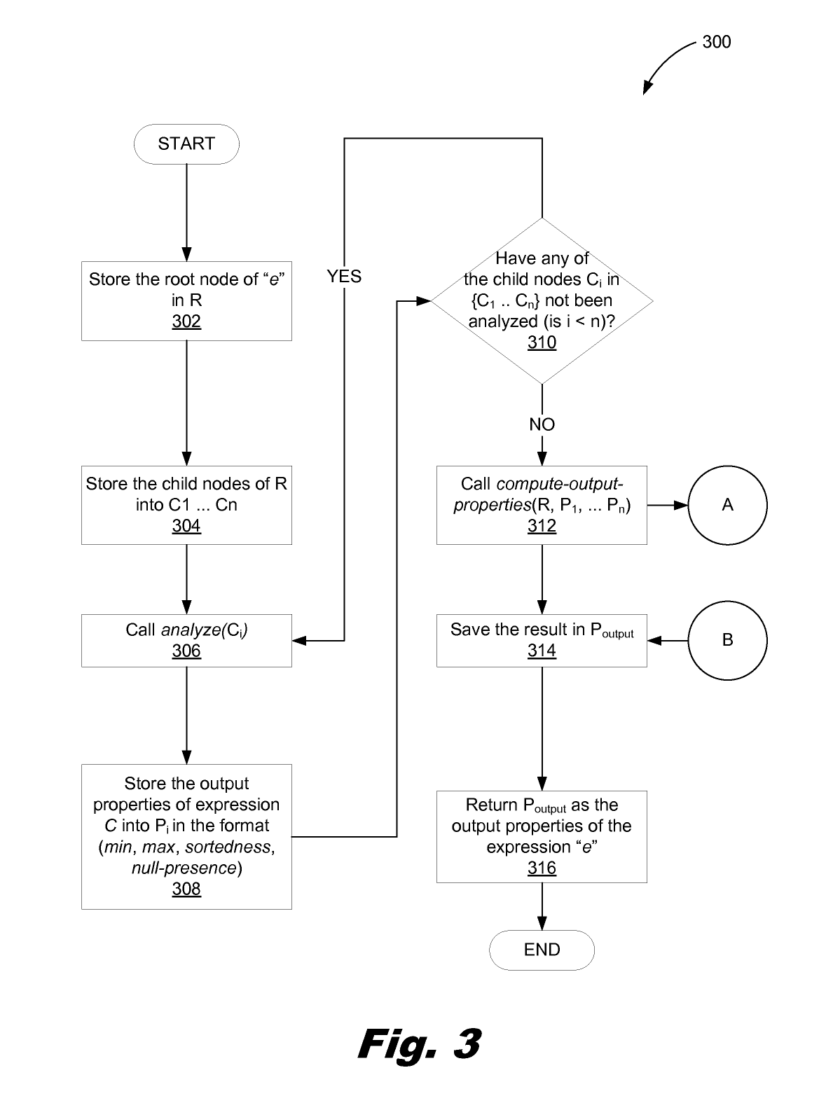

FIG. 3 is a flow chart depicting a method of analyzing an expression to infer the output data, according to one example of the principles described herein. Analyzing an expression to infer the output data properties may be similar to evaluating the expression for individual values. In one example, the method (300) of analyzing an expression to infer the output data may begin by storing (block 302) the root node “e” in R. For the function: analyze(e), where “e” is an expression, let R be the root of the abstract syntax tree (AST) of the expression “e.” For example, in FIG. 2, the root is the operator “=.”

Let C₁, C₂ . . . Cₙ be the child nodes of R. In FIG. 2, there are two child nodes; the column expression “txn.date” (202) and the function expression “timestamp” (208). The child nodes of R are then stored (block 304) into C₁, . . . Cₙ. In one example, the number “1” is stored as the variable for the first child node to be analyzed. For each child Cᵢ in {C₁, . . . Cₙ}, the system (100), and more particularly, the processor (150) of the client device (104) or a processor included within the analytic database (102), calls (block 306) analyze(C), and stores (block 308) the output properties of expression C (returned by the recursive call) into Pᵢ in the format (min, max, sortedness, null-presence). For example, in FIG. 2, recursively calling analyze on the “txn.date” and “timestamp” expressions returns the properties (min, max, sortedness, null-presence) for both expressions.

The method proceeds to block 310 where it is determined if any of the child nodes Cᵢ in {C₁ . . . Cₙ} have not been analyzed. In one example, the system (100) determines if i<n. If the last child node to be analyzed has not been reached (i.e., if i<n) (block 310, determination YES), then the method loops back to block 306 where the system (100), and more particularly, the processor (150) of the client device (104) or a processor included within the analytic database (102), calls (block 306) analyze(Cᵢ) in connection with the next child node to be analyzed. The system (100) stores (block 308) the output properties of expression C (returned by the recursive call) into Pᵢ in the format (min, max, sortedness, null-presence) for the next child node.

Thus, blocks 306 through 310 are performed any number of iterations until the last child node Cₙ has been reached. If the last child node to be analyzed has been reached (i.e., if i=n) (block 310, determination NO), then the system (100) calls (block 312) compute-output-properties(R, P₁, . . . Pₙ), saves (block 314) the result in Pₒᵤₜₚᵤₜ, and returns (block 316) P output as the output properties of the expression “e.”

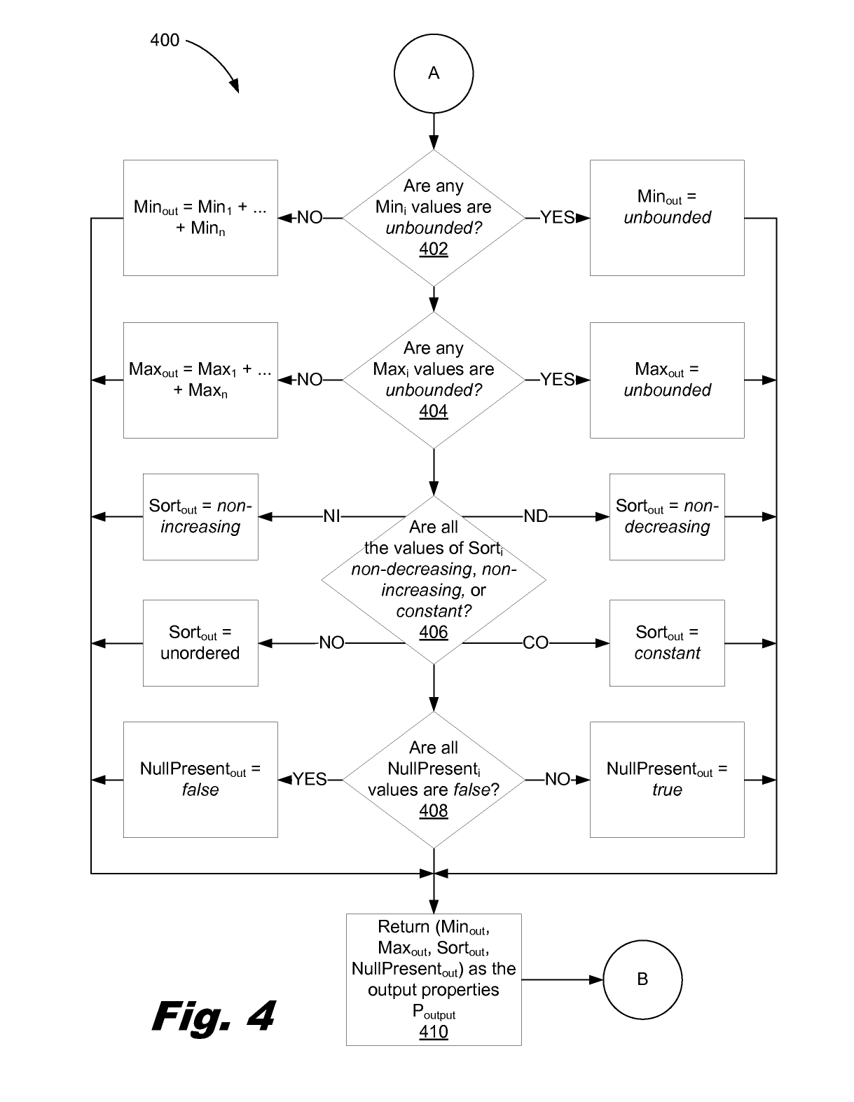

FIG. 4 is a flow chart depicting a method (400) of determining output properties of a single node, given the output properties of the children of the node in connection with A and B of FIG. 3, according to one example of the principles described herein. This method (400) uses the mathematical properties of the given node, in combination with the output properties of the children of the node, to compute the output properties of the node. In this example, the method is demonstrated for the “+” operator. The method for other operators and functions are determined based on the mathematical properties of the operator or function.

Consider compute-output-properties(R, P₁, . . . Pₙ), where R is the “+” operator and Pᵢ values are the output properties of the children of the “+” operator. Let Pᵢ=(Minᵢ, Maxᵢ, Sortᵢ, NullPresentᵢ) for each i in 1 to n. The system (100), and more particularly, the processor (150) of the client device (104) or a processor included within the analytic database (102), determines (block 402) if any of the Minᵢ values are unbounded, and, if so (block 402, determination YES), then Minₙᵤₜ=unbounded. If the Minᵢ values are not unbounded (block 402, determination NO), Minₒᵤₜ=Min₁+ . . . +Minₙ.

The system (100), and more particularly, the processor (150) of the client device (104) or a processor included within the analytic database (102), determines (block 404) if any of the Maxᵢ values are unbounded (block 404). If any of the Maxᵢ values are unbounded (block 404, determination YES), then Maxₒᵤₜ=unbounded. If the Maxᵢ values are not unbounded (block 404, determination NO), then Maxₒᵤₜ=Max₁+ . . . +Maxₙ.

The system (100), and more particularly, the processor (150) of the client device (104) or a processor included within the analytic database (102), determines (block 406) if all the Sortᵢ values are non-decreasing, non-increasing, or constant. If all the Sortᵢ values are sorted non-decreasing (block 406, determination ND), then Sortₒᵤₜ=nondecreasing. If all the Sortᵢ values are sorted non-increasing (block 406, determination NI), then Sortₒᵤₜ=non-increasing. If all the Sortᵢ values are sorted constant (block 406, determination CO), then Sortₒᵤₜ=constant. Otherwise (block 406, determination NO), Sortₒᵤₜ=unordered.

The system (100), and more particularly, the processor (150) of the client device (104) or a processor included within the analytic database (102), determines (block 408) if all of the NullPresentᵢ values are false (block 408, determination YES), then NullPresentₒᵤₜ=false. If any of the NullPresentᵢ values are true (block 408, determination NO), then NullPresentₒᵤₜ=true. The system (100), and more particularly, the processor (150) of the client device (104) or a processor included within the analytic database (102), then returns (block 410) (Minₒᵤₜ, Maxₒᵤₜ, Sortₒᵤₜ, NullPresentₒᵤₜ) as the output properties Pₒᵤₜₚᵤₜ.

The above method encodes the mathematical properties of the “+” operator. For example, the subprocess “if any of the Minᵢ values are unbounded, then Minₒᵤₜ=unbounded. Else Minₒᵤₜ=Min₁+ . . . +Minₙ” encodes the property that the minimum value of the sum of a number of values is the sum of the minimum of those values.

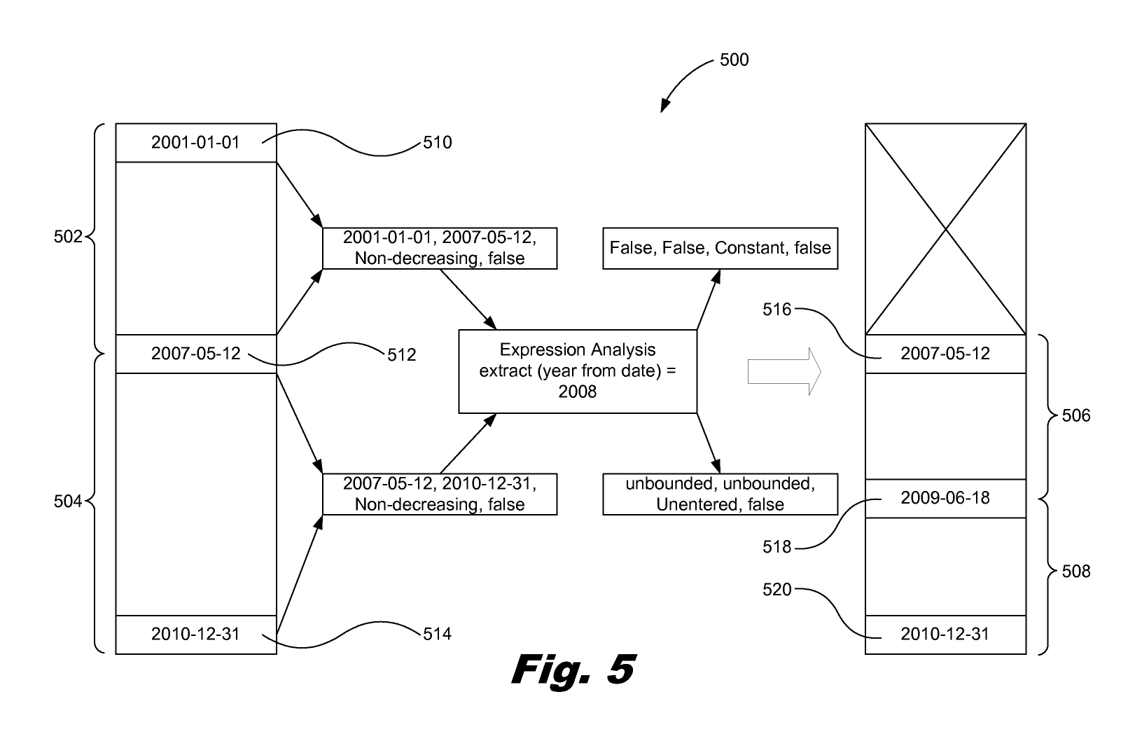

FIG. 5 is a block diagram of a predicate evaluation (500) for a query, according to one example of the principles described herein. During predicate evaluation (500), the expression analysis frame-work is used to perform a binary search within each container (502, 504, 506, 508). For each container, first (510), last (514), and mid-point (512) values of the attribute are determined using disk seeks. In one example, the records within the containers (502, 504) are stored in a sorted manner. The first (510), last (514), and mid-point (512) values of the attribute are then used to create value ranges (502, 504) for the column reference in the predicate. The value ranges (502, 504) are used as inputs to the expression analysis framework, and if the predicate can never be true for some range (502), then the values for that range (502) are never fetched off disk. For exact value or range look-ups, this technique is similar to index look-ups. However, as described above, the expression analysis framework allows for this to be performed for complex predicates as well. For example, suppose the data for the txn table is stored sorted by the date column, and there is a single container on disk for this column. FIG. 5 shows the predicate evaluation for the query:

SELECT * FROM tx
WHERE extract(year from date) = 2008

The first (510), last (514), and mid-point (512) values are used to generate two value ranges:
(2001-01-01, 2007-05-12, Non-decreasing, false) and
(2007-05-12, 2010-12-31, Non-decreasing, false)
These are then used as inputs to the expression analysis framework, which indicates that the predicate can never be true for the first range (502), and it could be true or false for the second range (504). Then, predicate evaluation is skipped for the entire first range (502) as indicated by the crossed-out portion in FIG. 5, and this process is repeated for the second range comprising ranges 306 and 308.

Within the value range of (2007-05-12, 2010-12-31, Non-decreasing, false), the analytic database (102) may again determine first (516), last (518), and mid-point (520) values of the attribute for each container using disk seeks. The first (516), last (518), and mid-point (520) values are then used to create value ranges (506, 508) for the column reference in the predicate. The value ranges (506, 508) are used as inputs to the expression analysis framework, and if the predicate can never be true for some range (508), then the values for that range (508), for example, (2009-06-18, 2010-12-31, Non-decreasing, false) are never fetched off disk. The above process is performed for any number of iterations among any number of subsections of the table column.

In one example, the analytic database (102) determines the mid-point values (512, 520) by choosing the middle record within the column. In another example, the analytic database (102) determines the mid-point values (512, 520) by choosing any arbitrary record within the range. The analytic database, using the above-described expression analysis framework yields a logarithmic run-time.

An analytic database such as, for example, a VERTICA® analytic database's comprises a query optimizer that uses cardinality estimates to cost the various plans that it considers. One of the heuristics used by the optimizer is that single table predicates are pushed as close to the table access as possible. Thus, in order to estimate cardinalities of base relations in the presence of predicates, the optimizer is able to estimate the selectivity of various predicates. How the expression analysis framework is leveraged to estimate selectivities for single and multiple table predicates (e.g., join predicates) will now be described.

Users periodically run a statistics gathering tool, which creates or updates summary data for each column of each table that the tool is run on. Among the summary data for a column is a histogram consisting of some number of buckets of values present in the column, along with the total number of values falling in each bucket. Thus, a bucket Bᵢ in the histogram may be represented by the tuple (Lᵢ, Hᵢ, Cᵢ), where Lᵢ and Hᵢ are the lower and upper bounds of the bucket, and Cᵢ is the number of values in the bucket. Such histograms may be used for equality and range predicate selectivity estimation. However, in an analytic database such as, for example, a VERTICA® analytic database, the power of the expression analysis framework provides for estimation of selectivities for arbitrarily complex predicates.

For example, consider a query that selects all rows of the txn table whose date falls in either January, 2008 or June, 2009:

| SELECT * FROM txn | |
|---|---|
| WHERE (extract (year from date) = 2008 AND | |
| | extract (month from date) = 0) |
| OR | (extract (year from date) = 2009 AND |
| | extract (month from date) = 5) |

Suppose the histogram for the date column has K buckets Bᵢ=(Lᵢ, Hᵢ, Cᵢ), 1≦i≦K. Let n(condition) denote Σᵢ₌₀^{K}Cᵢ: condition, i.e., the total number of rows in buckets satisfying the condition. Let n=Σᵢ₌₀^{K}Cᵢ be the total number of rows in all buckets. Then, the selectivity of a predicate P is estimated as:

$$σ ( P ) = \frac{n ( P = True ) + α \cdot n ( P = True ⋁ False}{n}$$

α is a “discount” term for buckets where the predicate might be true or false, and is a fraction between 0 and 1. In the degenerate case, where the predicate could be true or false in every bucket, the estimated selectivity becomes α. For a bucket Bᵢ, the bounds Lᵢ and Hᵢ are used to construct a value range for the column reference, and this is used as input to the expression analysis framework. The output value range indicates whether the predicate is always true, never true, or could be true or false. Within any bucket whose bounds are not NULL, the column reference cannot be NULL, and hence the predicate's value will not be unknown.

For predicates with multiple columns, for example, m columns, if independence among the column values is assumed, then the combined histogram can be thought of as an m dimensional hypercube. Each cell in the hypercube corresponds to exactly one bucket from each histogram, and can be represented by a vector with m elements (Bᵢ_{₁},Bᵢ_{₂}, . . . Bᵢ_{ₘ}); ∀jε{1 . . . m}, 1≦iₖ≦Kⱼ. The cardinality of a cell may be defined as |(Bᵢ_{₁}, Bᵢ_{₂}, . . . Bᵢ_{ₘ})|=Πⱼ₌₁^{m}Cᵢ_{ⱼ}, i.e., the product of row counts of each bucket corresponding to the cell.

Let n(condition)=Σ|(Bᵢ_{₁},Bᵢ_{₂}, . . . Bᵢ_{ₙ})|: condition denote the total cardinality of cells satisfying the condition, and n=Σ|(Bᵢ_{₁},Bᵢ_{₂}, . . . Bᵢ_{ₘ})| denote the total cardinality of all cells in the hypercube. Then, the selectivity of an m-column predicate is again estimated as:

$$σ ( P ) = \frac{n ( P = True ) + α \cdot n ( P = True ⋁ False}{n}$$

Using the expression analysis framework for such selectivity estimation has several benefits such as, for example, code reuse and easy extensibility. For instance, the formula for estimating the cardinality of a cell in the histogram hypercube assumes independence among the columns. The use of multidimensional histograms fits nicely into this framework, since if the true cell counts were known, using those in the formula would yield higher accuracy with minimal code changes.

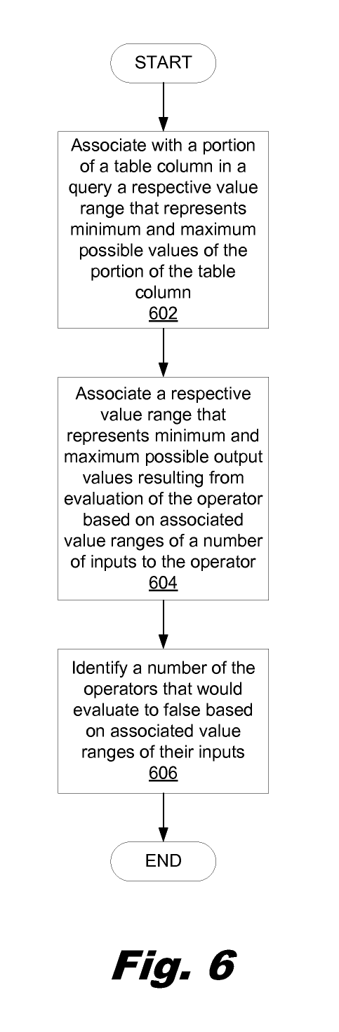

FIG. 6 is a flowchart depicting a method of eliminating records from a query result in a database expression analysis, according to one example of the principles described herein. The method may begin with the analytic database (102) associating (block 602) with each table column in a database query a respective value range that represents minimum and maximum possible values of the table column. In one example, the database query comprises a number of operators. The analytic database (102) then associates (block 604) a respective value range that represents minimum and maximum possible output values resulting from evaluation of the operator based on associated value ranges of a number of inputs to the operator. This may be performed for each of a number of the operators in the query.

The analytic database (102) identifies (block 606) a number of the operators that would evaluate to false based on associated value ranges of their inputs. As described above, these operators that would evaluate to false based on associated value ranges of their inputs would then be disregarded in further analysis. This yields an exponentially faster run-time and will return data to a user faster. The method thus evaluates the query without evaluating the identified operators.

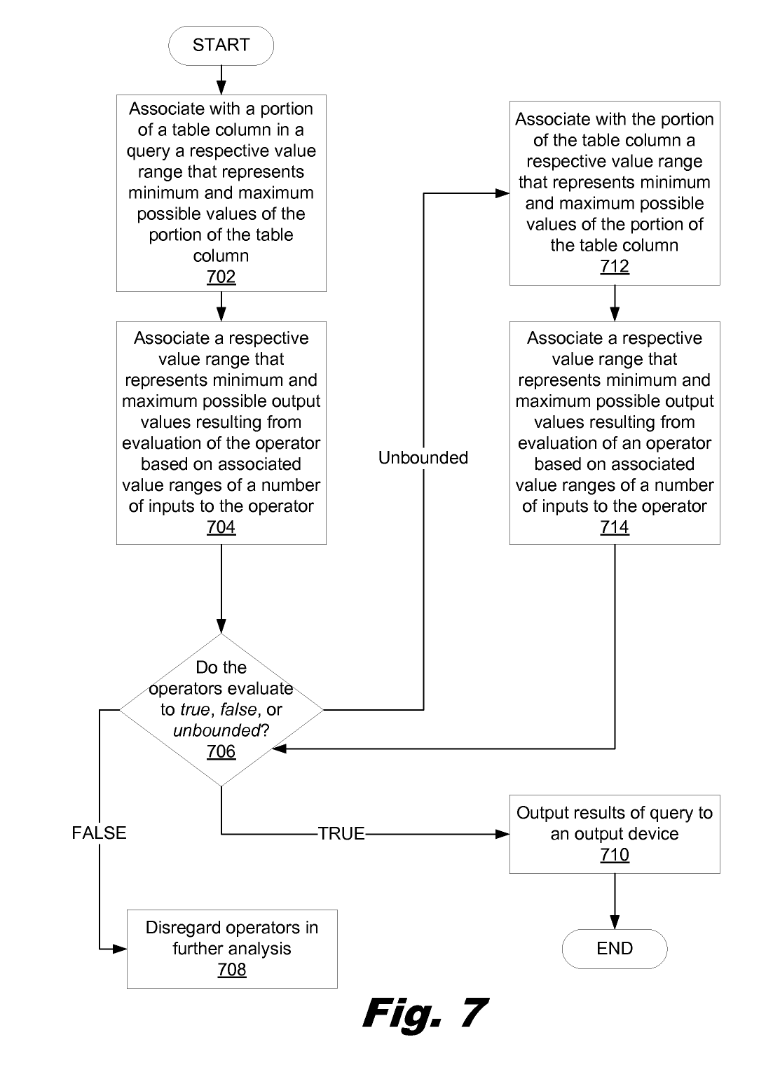

Blocks 602 through 606 may be performed any number of iterations until portions of the records have been removed from the results of the query, and the query has been satisfied. FIG. 7 is a flowchart depicting a method of eliminating records from a query result in a database expression analysis, according to another example of the principles described herein. The method of FIG. 7 may begin with the analytic database (102) associating (block 702) with each table column in a database query a respective value range that represents minimum and maximum possible values of the table column. In one example, the database query comprises a number of operators. The analytic database (102) then associates (block 704) a respective value range that represents minimum and maximum possible output values resulting from evaluation of the operator based on associated value ranges of a number of inputs to the operator. This may be performed for each of a number of the operators in the query.

The analytic database (102) then determines (block 706) whether a number of the operators evaluate to true, false, or unbounded based on associated value ranges of their inputs. As described above, operators that would evaluate to false (block 706, determination FALSE) based on associated value ranges of their inputs would then be disregarded (block 708) in further analysis. This yields an exponentially faster run-time and will return data to a user faster. The method thus evaluates the query without evaluating the operators identified as false.

If the operators evaluate to true (block 706, determination TRUE) based on associated value ranges of their inputs, then these operators are output (block 710) as results of the query to an output device (166). Thus, in this scenario, the analytic database (102) has found a set of records within the database for which the query is satisfied.

If the operators evaluate to unbounded (block 706, determination UNBOUNDED) based on associated value ranges of their inputs, then the analytic database (102) associates (block 712) with the portion of the table column remaining after disregarding operators in further analysis as described in block 708 a respective value range that represents minimum and maximum possible values of that portion of the table column. The analytic database (102) then associates a respective value range that represents minimum and maximum possible output values resulting from evaluation of an operator based on associated value ranges of a number of inputs to the operator. The analytic database (102) then again determines (block 706) whether a number of the operators evaluate to true, false, or unbounded based on associated value ranges of their inputs. In this manner, the analytic database (102) removes records or portions of the table column from further analysis until a group of operators that evaluate to true are found. Once the query has been satisfied, the records corresponding to a number of operators that evaluate to true are returned to a user and output to an output device (166) such as a display device or printing device.

Some experimental results that demonstrate faster query execution times achieved through the use of expression analysis will now be described. Experiments conducted in the context of partition pruning will be presented first, followed by experiments conducted in the context of value index.

First, with regard to experiments conducted in the context of partition pruning, the experiments were conducted on Schema 2 described in connection with FIG. 2. The tables item and txn were loaded with 10 million rows and 1 billion rows, respectively. The data was generated through a random data generator, with the following restrictions: The data for the column itm_id of table txn was made to respect the foreign key constraint and the data for the date column of table txn was made to span over 11 years. The table txn was partitioned over each quarter of each year, as described above in connection with Schema 2, with the data resulting in 44 partitions, with one container per partition, per column. The table item was not partitioned and resulted in one container per column. The experiments were run on a single node VERTICA® analytic database instance.

The queries used are shown below, and highlight the advantage of partition pruning. None of the predicates are the same as the partitioning expression for the table, and some predicates are quite complex, and hence not amenable to simple index lookup schemes.

Q1: select count (*) from txn
where extract (year from date)=2005;
Q2: select count (*) from txn
where (extract (year from date)=2004 and

extract (month from date)=12) or

(extract (year from date)=2005 and

extract(month from date)=0);

Q3: select count (*) from txn t
where extract (day from t.date) between 25 and 31

and extract(month from t.date)=12;

Q4: select count( )
from txn t, item i
where titm_id=i.id

and i.name=‘item number 5’

and extract(year from t.date)=2004

and extract(month from t.date)=4;

Table 1 shows the execution times for queries Q1, Q2, Q3, and Q4 with and without partition pruning. The query times without partition pruning were obtained by turning the feature off using a database option. Table 1 also shows the number of containers that were pruned by the pruning logic for each of these queries.

TABLE 1
Query performance with and without partition pruning

| | Time (sec) with | Time (sec) without | Partitions |
|---|---|---|---|
| Query | pruning | pruning | eliminated |
| Q1 | 0.81 | 6.93 | 37 |
| Q2 | 0.41 | 14.1 | 40 |
| Q3 | 2.14 | 8.39 | 31 |
| Q4 | 0.67 | 7.89 | 40 |

As demonstrated in Table 1, partition pruning enables almost an order of magnitude improvement in query times, even for complex predicates. The performance advantage depends on how many partitions can be pruned out using expression analysis as, for example, query Q3 demonstrates.

Experiments were conducted on the same schema (Schema 2) and data as the partition pruning experiments. For these experiments, the table txn was not partitioned and had one container per column. The table item was also not partitioned and resulted in one container per column. The experiments were run on a single node VERTICA® analytic database instance.

The queries used to test value index performance are given below. As before, all the queries have complex predicates that are not amenable to simple value lookup schemes.

Q5: select count (*) from txn t
where extract (day from t.date) between 25 and 31

and extract (month from t.date)=12;

Q6: select count (*) from txn
where extract (year from date)=2005;
Q7: select count (*) from txn
where extract (year from date)=2005 and

extract (month from date)=4;

Q8: select count (*) from txn
where (extract (year from date)=2004 and

extract (month from date)=12) or

(extract (year from date)=2005 and

extract (month from date)=0);

Table 2 shows execution times for queries Q5, Q6, Q7, and Q8 both with and without using the value index scheme described above. The execution times without value indexing were obtained by disabling the feature using a database option.

TABLE 2
Query performance with and without value index

| | | Time (sec) without |
|---|---|---|
| Query | Time (sec) with analysis | analysis |
| Q5 | 0.69 | 8.37 |
| Q6 | 1.50 | 7.15 |
| Q7 | 0.61 | 7.53 |
| Q8 | 0.63 | 14.1 |

Again, almost an order of magnitude performance improvement is demonstrated by using the value index scheme. As, for example, query Q6 demonstrates, the advantage reduces if the predicate selectivity is high, while Q8 demonstrates that for complex predicates, which utilize more time to evaluate, value indexes give a bigger performance advantage.

An expression analysis framework for use by a variety of applications in an analytic database such as, for example, a VERTICA® analytic database has been described, and some applications in using the analytic database have been demonstrated. For partition pruning, expression analysis framework may be used to examine an arbitrary expression and determine any partitions that may skip fetching from disk, thereby improving performance. Using the expression analysis framework, a binary search on storage containers may be performed to eliminate the portions to read from disk. Lastly, a method of how the predicate selectivity for complex predicates can be estimated using the framework has been described.

There may exist several more applications that can be used with the expression analysis framework such as, for example, determining the sortedness of expressions, selectivity estimates for correlated columns, and a more sophisticated block based value index for unsorted columns.

The methods described above may be accomplished in conjunction with a computer program product comprising a computer readable medium having computer usable program code embodied therewith that, when executed by a processor, performs the above processes and methods. Specifically, the computer usable program code, when executed by a processor, associates with each table column in a query a respective value range that represents minimum and maximum possible values of the table column, associates a respective value range that represents minimum and maximum possible output values resulting from evaluation of an operator based on associated value ranges of a number of inputs to the operator, identifies a number of the operators that would evaluate to false based on associated value ranges of their inputs, and outputs records corresponding to a number of operators that evaluate to true to an output device. The computer usable program code, when executed by a processor, may also not analyzing and disregard those records for which the operators would evaluate to false.

The specification and figures describe a system and method of analyzing an expression to infer output data properties. The system and method stores, in a storage device, a root node “e” in R, in which “e” is an expression and R is the root node of the abstract syntax tree (AST) of the expression “e”, stores, in a storage device, a number of child nodes of R into C₁, . . . , Cₙ, stores, in the storage device, the value “1” the variable for the first child node to be analyzed, with a processor, calling analyze(Ci), stores, in the storage device, output properties of expression C into Pᵢ in the format (min, max, sortedness, null-presence),and determines if any of the child nodes Ci in {Cᵢ . . . Cₙ} has not been analyzed. If the last child node has been analyzed, with the processor, the system and method calls compute-output-properties(R, P₁, . . . Pₙ), stores, in the storage device, the result in Pₒᵤₜₚᵤₜ, and returns Pₒᵤₜₚᵤₜ as the output properties of the expression “e.”

The system and method, using an analytical database, associates with each table column in a query a respective value range that represents minimum and maximum possible values of the table column, associates a respective value range that represents minimum and maximum possible output values resulting from evaluation of an operator based on associated value ranges of a number of inputs to the operator, identifies a number of the operators that would evaluate to false based on associated value ranges of their inputs, and outputs records corresponding to a number of operators that evaluate to true to an output device. The system and method further does not analyze records for which the operators would evaluate to false. In this manner, the system and method evaluate a query without evaluating the identified operators.

This system and method of analyzing an expression to infer output data properties may have a number of advantages, including, for example: 1) better compression, allowing merge joins and pipelined aggregation (also referred to as stream aggregation). Often primary key and other high cardinality columns are stored sorted; and 2) the present system and method yields a logarithmic run-time.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of analyzing an expression to infer output data properties, comprising:
storing, in a storage device, a root node “e” in R, in which “e” is an expression and R is a root node of an abstract syntax tree (AST) of the expression “e”;
storing a number of child nodes of R into C₁, . . . Cₙ;
with a processor coupled to the storage device, calling analyze(Cᵢ);
storing output properties of expression C into Pᵢ i; and
determining if any of the child nodes Cᵢ in {C₁ . . . Cₙ} has not been analyzed;
in which if the last child node has been analyzed:
with the processor, calling compute-output-properties(R, P₁, . . . Pₙ);
storing, in the storage device, the result in Pₒᵤₜₚᵤₜ: and
returning Pₒᵤₜₚᵤₜ as the output properties of the expression “e.”

2. The method of claim 1, in which if the last child node has not been analyzed:
with the processor, calling analyze(Cᵢ) in connection with the next child node to be analyzed;
storing, in a storage device, output properties of expression C into Pᵢ; and
determining if any of the child nodes Cᵢ in {C₁ . . . Cₙ} has not been analyzed.

3. The method of claim 2, in which with a processor, calling analyze(Cᵢ), storing, in a storage device, output properties of expression C into Pᵢ, and determining if any of the child nodes Cᵢ in {C₁ . . . Cₙ} has not been analyzed is performed any number of times.

4. The method of claim 2, in which with a processor, calling analyze(Cᵢ), storing, in a storage device, output properties of expression C into Pᵢ, and determining if any of the child nodes Cᵢ in {C₁ . . . Cₙ} has not been analyzed is performed until Cₙ has been analyzed.

5. The method of claim 1, in which calling compute-output-properties(R, P₁, . . . Pₙ) comprises:
with the processor, determining if any of the Minᵢ values are unbounded;
with the processor, determining if any of the Maxᵢ values are unbounded;
with the processor, determining if all the Sortᵢ values are non-decreasing, non-increasing, or constant;
with the processor, determining if all of the NullPresentᵢ values are false; and
returning (Minₒᵤₜ, Maxₒᵤₜ, Sortₒᵤₜ, NullPresentₒᵤₜ) as the output properties Pₒᵤₜₚᵤₜ.

6. The method of claim 5, in which, if any of the Minᵢ values are unbounded, then setting Minₒᵤₜ=unbounded, and if Minᵢ values are not unbounded, then setting Minₒᵤₜ=Min₁+ . . . +Minₙ.

7. The method of claim 5, in which, if any of the Maxᵢ values are unbounded, then setting Maxₒᵤₜ=unbounded, and if the Maxᵢ values are not unbounded, then setting Maxₒᵤₜ=Max₁+ . . . +Maxₙ.

8. The method of claim 5, in which:
if all the Sort, values are sorted non-decreasing, then setting Sortₒᵤₜ=non-decreasing;
if all the Sortᵢ values are sorted non-increasing, then setting Sortₒᵤₜ=non-increasing;
if all the Sortᵢ values are sorted constant, then setting Sortₒᵤₜ=constant; and
if all the Sortᵢ values are not sorted non-decreasing, non-increasing, or constant, then setting Sortₒᵤₜ=unordered.

9. The method of claim 5, in which:
if all of the NullPresentᵢ values are false, then setting NullPresentₒᵤₜ=false; and
if any of the NullPresentᵢ values are true, then setting NullPresentₒᵤₜ=true.

10. A data processing system comprising:
a database to store data;
a processor communicatively coupled to the database to issue a query to the database in which, upon receipt of the query from the processor, the database analyzes a number of child nodes to determine a number of properties of the an expression associated with the child nodes; and
an output device to output the properties to a user.

11. The data processing system of claim 10, in which the database is a programmable processor, a computer, a system on a chip, an analytic database, a relational database, a non-relational database, a structured database, a stream processing system, an in-memory database, a key-value database, or combinations thereof.

12. A method for performing an evaluation for a query comprising:
with a database, associating with a portion of a table column in a query a respective value range that represents minimum and maximum possible values of the portion of the table column;
associating a respective value range that represents minimum and maximum possible output values resulting from evaluation of an operator based on associated value ranges of a number of inputs to the operator; and
identifying a number of the operators that would evaluate to false based on associated value ranges of their inputs.

13. The method of claim 12, in which identifying a number of the operators that would evaluate to false based on associated value ranges of their inputs further comprises not analyzing records for which the operators would evaluate to false.

14. The method of claim 12, further comprising:
identifying a number of the operators that evaluate to true based on associated value ranges of their inputs; and
outputting records corresponding to a number of operators that evaluate to true to an output device.

15. The method of claim 12, further comprising:
identifying a number of the operators that evaluate to unbounded based on associated value ranges of their inputs, the unbounded operators comprising a portion of the table column;
with a database, associating with the portion of the table column a respective value range that represents minimum and maximum possible values of the portion of the table column;
associating a respective value range that represents minimum and maximum possible output values resulting from evaluation of an operator based on associated value ranges of a number of inputs to the operator; and
identifying a number of the operators that would evaluate to false based on associated value ranges of their inputs.

16. The method of claim 15, in which the method of claim 4 is performed any number of iterations until the operators evaluate to true.

17. The method of claim 12, in which a minimum or maximum value for a respective value range of an operator is unknown.

18. The method of claim 12, in which the table column is partitioned, and in which the value range associated with the table column comprises a value range for each partition.

19. The method of claim 12, in which the table column is partitioned into a plurality of partitions, and in which each partition's values are stored in a sorted order.
